(19) United States
(12) Patent Application Publication
(10) Pub. No.: US 2012/0221148 A1
(43) Pub. Date: Aug. 30, 2012

(54) REAL-TIME PERFORMANCE ENABLED BY A MOTION PLATFORM

(75) Inventors: Jean-Francois MÉNARD, Boucherville (CA); Sylvain Trottier, St-Lambert (CA); Michel Bérubé, Contrecoeur (CA); Philippe Roy, St-Bruno (CA)

(73) Assignee: D-Box Technologies inc., Longueuil (CA)

(21) Appl. No.: 13/036,118

(22) Filed: Feb. 28, 2011

(51) Int. Cl. G05D 3/12

(52) U.S. Cl. 700/275

(57) ABSTRACT

The present document describes a system and method for controlling the movements of a motion platform in real-time based on the movements of a remote subject. For example, the user of the motion platform may experience movements/vibrations that correspond to the movements of a motorcycle in a live racing event. The system comprises a motion capture system which determines the movement of the remote subject. The output of the motion capture system is used by an encoder to generate motion signals which cause the motion platform to produce movements which correspond to the movements of the remote subject. The motion signals are sent to the motion platform over a communication link. In an embodiment, the remote subject is provided with one or more motion sensors which communicate with the motion capture system over another communication link.

### BACKGROUND

(a) Field

The subject matter disclosed generally relates to the field of motion platforms.

(b) Related Prior Art

It is becoming more and more popular to use motion-enabled chairs in theatres (or at home) to experience movements that are synchronized with the events displayed on the screen. An example of such motion-enabled chairs is described in co-owned U.S. Patent Publication No. 20100090507 entitled Motion-Enabled Movie Theatre Seat, which is incorporated herein by reference in its entirety.

Generally, motion-enabled chairs include one or more actuators connected to the base of the seat to produce vibrations and movements which are synchronized with and correspond to the events displayed on the screen. The actuators are driven by motion signals. The motion signals are generated by a central controller to induce and synchronize the vibrations/movements with the events displayed on the screen.

In this type of systems, the movements of the chair are pre-programmed. In other words, the central controller generates motion signals in accordance with commands which are pre-entered by a motion designer or a programmer. Generally, the motion designer or programmer watches the video and enters movements and vibrations where they feel appropriate.

Because in these types of applications, movements and vibrations are pre-programmed, they do not easily lend themselves to use the motion platforms in real-time with live events such as a live concert performance, a formula I race, a circus show, a hockey game, etc.

Accordingly there is a need for a system and method which enable a user to experience real-time performance based on the movements of a remote subject.

### SUMMARY

According to an embodiment, there is provided a method for rendering, to a user, a live event on a playback system, the live event, in which a subject participates, taking place at a first location and from which at least one of audio and video are captured. The playback system comprising a motion platform, and at least one of an audio playback system and a video playback system at a second location remote from the first location. The at least one of an audio playback system and a video playback system respectively for reproducing the captured at least one of audio and video. The method comprises:
capturing motion data representative of movements of the subject;
transmitting the motion data to a motion encoder;
the motion encoder generating motion signals for inducing motion to the motion platform, the motion corresponding to the motion data representative of movements of the subject; and
sending the motion signals to the motion platform to induce the motion to the motion platform synchronously with the at least one of audio, produced by the audio playback system, and video, produced by the video playback system, representative respectively of at least one of the audio and the video environment of the subject thereby synchronously rendering the motion, and at least one of the audio and the video to the user.

According to another embodiment, there is provided a system for rendering to a user a live event on a playback system, the live event, in which a subject participates, taking place at a first location and from which at least one of audio and video are captured. The system comprises, at the first location:
a motion capture system for capturing motion data representative of movements of the subject; and
a transmitter for transmitting the motion data to a second location where the live event will be rendered on the playback system by synchronously producing a motion representative of the captured motion, with the captured at least one of audio and video to the user.

According to another embodiment, there is provided a system for controlling the movements of a motion platform in real-time based on the movements of a remote subject. The system comprises:
a motion capture system for monitoring the movements of the remote subject;
a central encoder for producing motion signals which cause the motion platform to produce movements corresponding to the movements of the remote subject; and
a first communication link for sending the motion signals from the central encoder to the motion platform in real-time.

According to another embodiment, wherein the motion capture system comprises one or more motion sensors such as accelerometers, gyrometers, magnetometers, inclinometers, and rotational or translational encoders.

According to another embodiment, the system for controlling motion further comprises the motion platform which is adapted to seat one or more users.

According to another embodiment, there is provided a method for controlling movements of a motion platform in real-time based on the movements of a remote subject. The method comprises:
monitoring the movements of the remote subject in real-time;
generating motion signals which cause the motion platform to produce movements corresponding to the movements of the remote subject;
sending the motion signals to the motion platform in real-time.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a perspective view showing an example of a motion-enabled chair that may be used as a motion platform in one of the embodiments;

FIG. 2 is a schematic diagram illustrating an example of a system that allows a user to experience real-time performance based on the movements of a remote subject, in accordance with an aspect;

FIG. 3 is a schematic diagram illustrating an example of a system in which the generation of motion signals is based upon a graphical interpretation and processing of real-time images of an subject monitored on camera, in accordance with another aspect;

FIG. 4 is a schematic diagram illustrating a system for rendering a live event according to an embodiment;

FIG. 5 is a block diagram illustrating a method for rendering a live event according to an embodiment; and

FIG. 6 is a block diagram of a system for producing multi-axis vibro-kinetic signals used in controlling the movements of a motion platform.

It will be noted that throughout the appended drawings, like features are identified by like reference numerals.

### DETAILED DESCRIPTION OF THE PREFERRED EMBODIMENTS

The present document describes a system and method for controlling the movements of a motion platform in real-time based on the movements of a remote subject. For example, the user of the motion platform may experience movements/vibrations that correspond to the movements of a motorcycle in a live racing event. The system comprises a motion capture system which determines the movement of the remote subject. The output of the motion capture system is used by an encoder to generate motion signals (aka multi-axis vibro-kinetic signals) which cause the motion platform to produce movements which correspond to the movements of the remote subject. Some signal processing may be required to generate motion signals. The signal processing may include signal altering, delaying, or filtering. The motion signals are sent to the motion platform over a communication link. In an embodiment, the remote subject is provided with one or more motion sensors which communicate with the motion capture system over another communication link. In another embodiment, the motion capture system comprises a camera for capturing images representative of movement of the remote subject and determining motion data therefrom.

The following embodiments are described with reference to a motion-enabled chair as a non limiting example of a motion platform. Different chairs and/or platforms may be used in the present embodiments without departing from the scope of this document. Other examples of motion platforms also include shakers and tactile transducers.

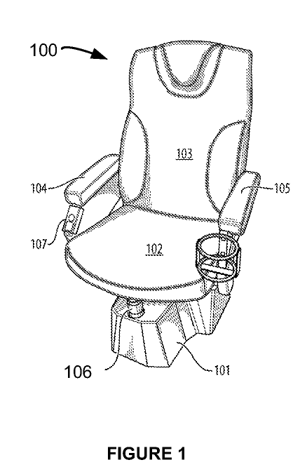

FIG. 1 illustrates an example of a motion-enabled chair 100 as shown in co-owned U.S. Patent Publication No. 20100090507. In the example shown in FIG. 1, the base (not shown) of the motion-enabled chair 100 is covered by a protective cover 101. The seating portion of the motion-enabled chair 100 is very similar to a standard movie chair or seat and comprises a seat base 102, a backrest 103 and armrests 104-105. Between the protective cover 101 and the seat base 102 there may be a protection skirt (not shown) for preventing users from injury while viewing a moving which comprising motion effects. The protection skirt is horizontally wrinkled and made of flexible material to adjust itself during the actuating (movement of the chair).

The chair includes one or more actuators 106 connected to the seat base 102, and a controller (not shown) to receive motion signal from an encoder (not shown) and interpret and transform the motion signal into drive signals for driving each actuator 106. The encoder generates the motion signals in accordance with the movements of a remote subject as will be described herein. Normally, a video and audio system (not shown) accompanies the motion-enabled chair 100 to enhance the immersive effect to the user.

Below the right armrest 104, a control panel 107 is accessible to the user for controlling the intensity (e.g., the amplitude range of the actuators 106) of the motion effect inducing in the motion-enabled chair 100. Some of the options (i.e., modes of operation) include “Off” (i.e., no motion), “Light” (i.e., reduced motion), “Normal” (i.e., regular motion), “Heavy” (i.e., maximum motion), “Discreet” (i.e., fully controllable motion level between “Off” and “Heavy”), and “Automatic”. In the “Automatic” mode, the motion-enabled chair 100 uses a sensor (not shown) to detect a characteristic of the user (e.g., weight, height etc.) and, based on the characteristic, determines the setting for the level of motion that will be induced in the motion-enabled chair 100.

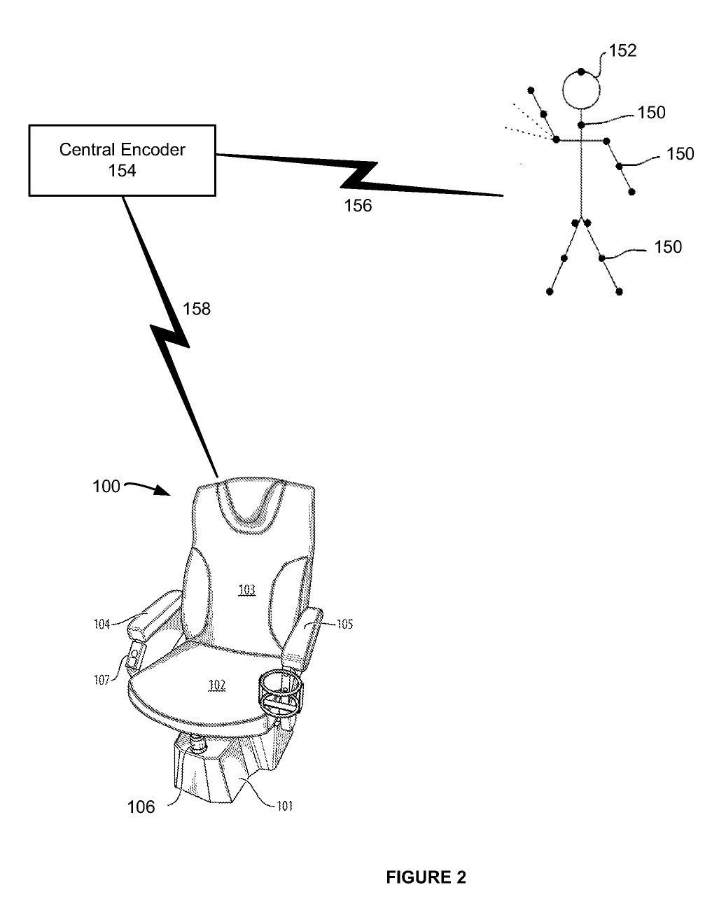

FIG. 2 illustrates an example of a system that allows a user to experience real-time performance based on the movements of a remote subject, in accordance with an aspect.

In the example shown in FIG. 2, one or more motion sensors 150 are mounted on a subject 152. The motion sensors 150 communicate with a central encoder 154 via a communication link 156 to transmit to the central encoder 154 information relating to their motion in real-time. The central encoder 154 is in communication with at least one motion-enabled chair 100 via a communication link 158. The motion-enabled chair 100 will not be further described here as it is the same as in FIG. 1.

The central encoder 154 provides the motion-enabled chair 100 with motion signals to control the actuators thereof in order to produce movements which correspond to the movements of the subject 152. The central encoder 154 receives the data transmitted from each motion sensor 150 and processes the data centrally in order to generate the motion signals.

If only one motion sensor 150 is provided on the subject 152, imitation/duplication of the movements in the motion-enabled chair 100 is simple to produce. However, in the case where more than one motion sensors 150 are provided on the subject 152, such as in the example of FIG. 2, the central encoder 154 takes into consideration the overall movement of the subject 152. Determination of the approximate movements that are to be produced in the motion-enabled chair 100 is based on at least:

1) The shape of the subject;

2) The output of each sensor provided on the subject; and

3) The position of each sensor on the subject 152; e.g., left side, right side, up, down, center, etc.

For example, if all the motion sensors experience an upward motion, the central encoder generates motion signals that cause the seat of the motion-enabled chair 100 to give the same or similar effect to the user. If the motion sensors positioned on the left side of the subject 152 move up and the motion sensors on the right side of the subject 152 move down, the central encoder generates motion signals that cause the seat to incline in a manner which reproduces the same effect, and so on.

Generation of the motion signals that are to be transmitted to the motion-enabled chair 100 is performed in real-time, with a latency that is substantially un-detectable by the user (occupant of the motion-enabled chair 100). The “real-time” criteria will vary depending on the contemplated application. As long as the motion effect is synchronized with the audio and video signals provided to the user, the motion platform is considered to provide a motion effect in real-time.

It is also to be noted that, according to an embodiment, at least one of: the subject 152, the central encoder 154, and the motion-enabled chair 100 is provided remotely from the others. Additionally, either one or both links 156 and 158 may embody one or more links and one or more types of link. Examples of these links may include: Bluetooth link, WiFi link, wireless link, optical link, wired link, internet link, Ethernet link, IR link etc. For example, the motion platform may be provided in a location where a live event takes place, whereby, the user experiences movements that correspond to the movements of a subject they watch directly on stage. In another embodiment, the user may be watching a live event aired on TV and experience movements that correspond to the movements of a subject which is displayed on the screen, in real-time.

In the embodiments described herein the motion sensors 150 may be selected from a wide variety of sensors available on the market such as accelerometers, gyrometers, magnetometers, inclinometers, and rotational or translational encoders.

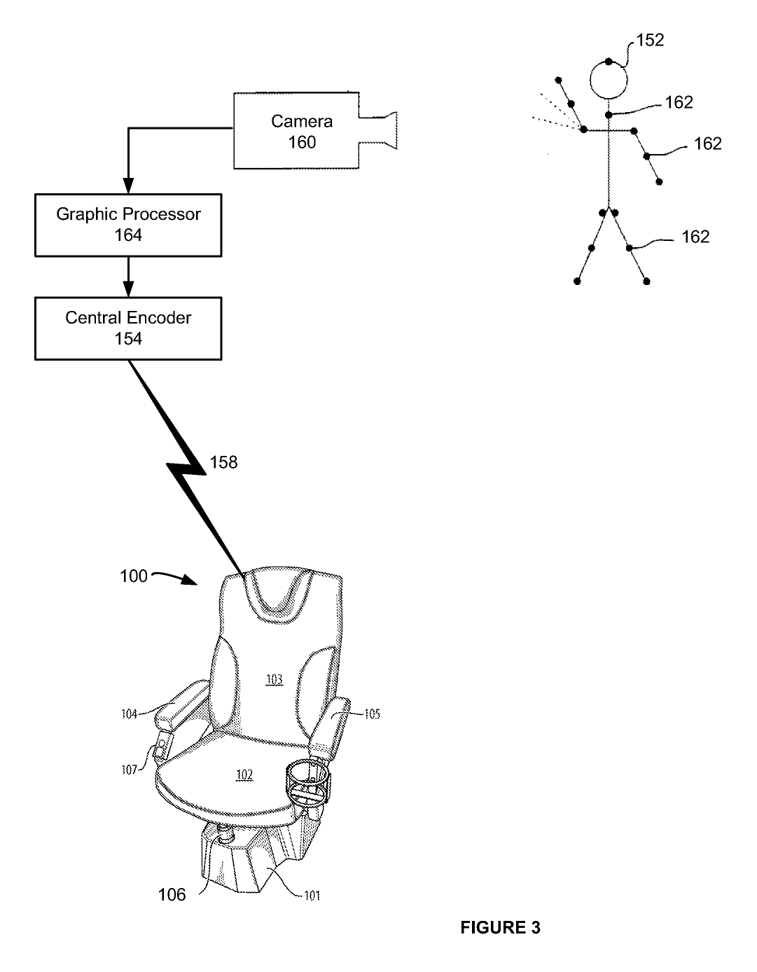

In another aspect, as shown in FIG. 3, generation of the motion signals is based upon a graphical processing of real-time images of a subject monitored on camera. As shown in FIG. 3, a camera 160 is provided which monitors the subject 152 as it moves. In an embodiment, the subject 152 is provided with one or more sensors 162. The one or more sensors 162 can be active or passive. In another embodiment, a GUI (Graphical User Interface) is provided (not shown) which allows a programmer (or the user) to choose a certain subject 152 to follow. A graphics processor 164 receives the video stream from the camera and processes the images to determine the movements of the subject 152. The movement of the subject can be measured in an absolute manner or relative to the background. The output of the graphics processor 164 is sent to the central encoder to generate motion signals for the motion-enabled chair 100. The motion-enabled chair 100 will not be further described here as it is the same as in FIG. 1. The

While in FIG. 3, the graphics processor 164 is shown to be separate from the central encoder 154, it is also possible to incorporate the two modules together in one device.

In the embodiments described herein, the users may be notified that the movements that they are experiencing correspond to the movements of which subject, e.g., the red car which is chased by the police. The notification may be displayed on the screen of a TV (if the event is aired on TV) or on a display provided in the motion-enabled chair 100.

In a further embodiment, the user may choose a subject from a variety of available subjects. For example, if in the live event, a white car is chasing a black car, and motion signals corresponding to the movements of each car are available, the user may choose to experience the movements of one of the cars or may switch between one car and the other during the event. Upon receiving the user selection at the central encoder 154, the central encoder 154 will provide the motion-enabled chair 100 on which the user is seated with motion signals that correspond to the subject chosen by the user.

In the examples described herein, the subject 152 is shown as being a person. However, the embodiments may be implemented with any type of subjects such as animals, cars, motorcycles, stages, complete rooms, etc.

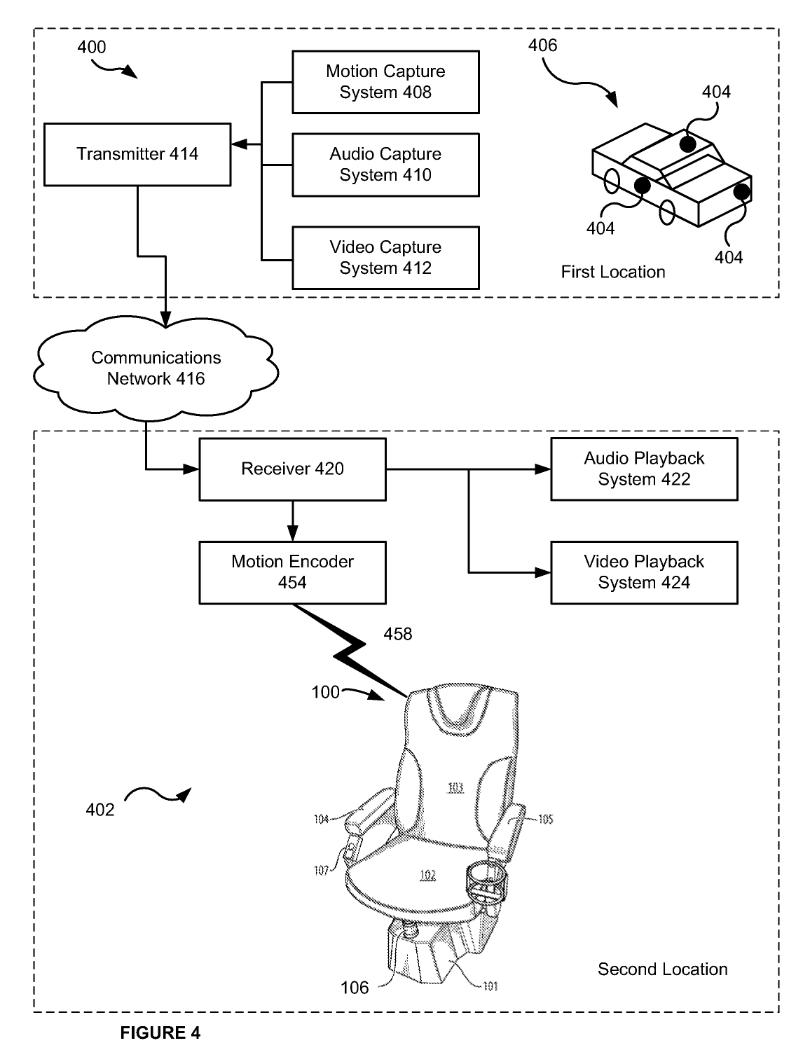

Now turning to FIG. 4, a rendering system 400 for rendering, to a user, a live event on a playback system 402 is shown. The live event, in which a subject 406 participates, takes place at a first location. In the present example, the subject 406 is a car on which motion sensors 404 are mounted.

The rendering system 400 comprises, at the first location, a motion capture system 408, an audio capture system 410 and a video capture system 412. The motion capture system 408 is for capturing motion data representative of movements of the subject 406. The audio capture system 410 and the video capture system 412 are respectively for capturing audio data and video data representative respectively of an audio and a video environment of the subject 406.

The rendering system 400 further comprises a transmitter 414 for transmitting the motion data, audio data and video data to a second location where the live event will be rendered on the playback system 402 by synchronously rendering motion, audio and video to the user (not shown) which normally sits in the motion-enabled chair 100. The motion-enabled chair 100 will not be further described here as it is the same as in FIG. 1.

The transmitter 414 communicates with the playback system 402 over a communications network 416. According to an embodiment, the communications network 416 is the Internet. Any other type of broadcast communication networks can also be used (wired or wireless).

According to an embodiment, the playback system 402 comprises a receiver 420, a motion encoder 454, a motion-enabled chair 100, an audio playback system 422 and a video playback system 424 at the second location. The audio playback system 422 and the video playback system 424 are for producing the audio and the video representative respectively of the audio and the video environment of the subject in the first location. The motion encoder 454 is for generating motion signals for sending to the motion-enabled chair 100 to induce the motion to the motion-enabled chair 100 synchronously with the audio and the video.

According to an embodiment, the method for synchronizing motion signals with audio and video signals is selected from any one of those described in the applicant's granted or pending patents such as U.S. Pat. No. 6,139,324, U.S. Pat. No. 7,680,451, U.S. Pat. No. 7,321,799, and US 2010/0135641 which are hereby incorporated by reference.

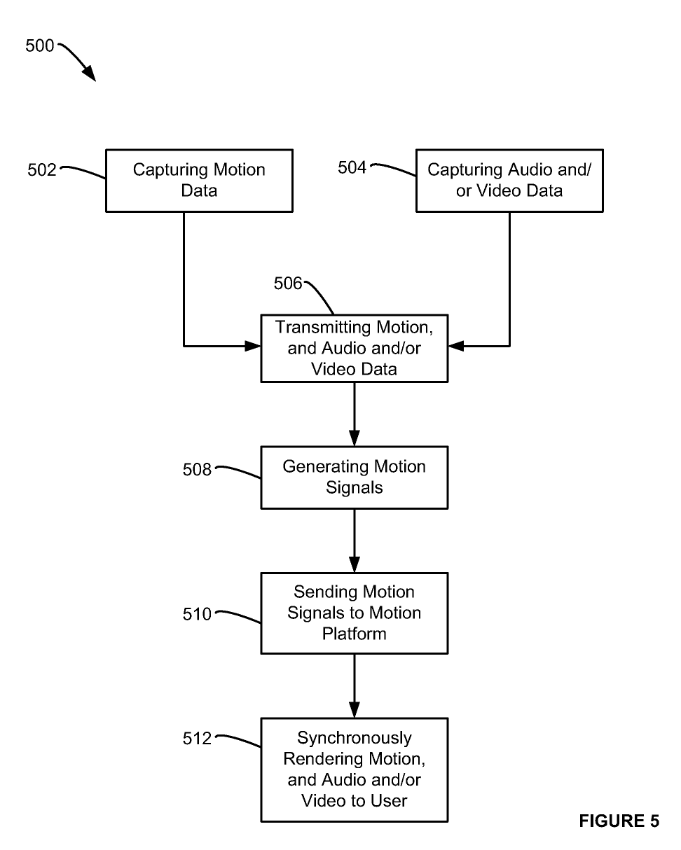

Now turning to FIG. 5, a block diagram of a method 500 for rendering to a user a live event on a playback system is shown. Refer to FIG. 4 for the physical context of the method. The method 500 comprises: capturing motion data representative of movements of the subject (step 502); capturing audio data and/or video data representative respectively of an audio and/or a video environment of the subject (step 504); transmitting the motion data, audio data and video data to a motion encoder, and the audio playback system and/or the video playback system respectively (step 506); the motion encoder generating motion signals for inducing motion to the motion platform, the motion corresponding to the motion data representative of movements of the subject (step 508); and sending the motion signals to the motion platform (step 510) to induce the motion to the motion platform synchronously with an audio and/or a video produced by the audio playback system and/or the video playback system respectively and representative respectively of the audio and/or the video environment of the subject thereby synchronously rendering the motion, the audio and/or the video to the user (step 512). Alternatively to step 504 a time reference or time code can be captured. The time reference is used in synchronizing the motion signals with the audio and/or video in step 512.

According to an embodiment, the motion data representative of movements of the subject is in a range of frequencies between about 0 Hz and 600 Hz. Preferably, the range is between 0 and 100 Hz.

According to another embodiment, the motion-enabled platform is replaced by another type of movement inducing device such as an exoskeleton (not shown) or any other system which can be worn by a user or which principally has an effect on the sense of touch of a user (i.e., not smell, hearing, sight or taste). An example of an exoskeleton used to control a robot is described in U.S. Pat. No. 7,410,338. In the present system, a first exoskeleton is used in controlling the movement of the user. The first exoskeleton reproduces the movements of another user. As discussed herein, the movements of the other user are obtained from sensors. The movements of the other user could also be captured by another exoskeleton.

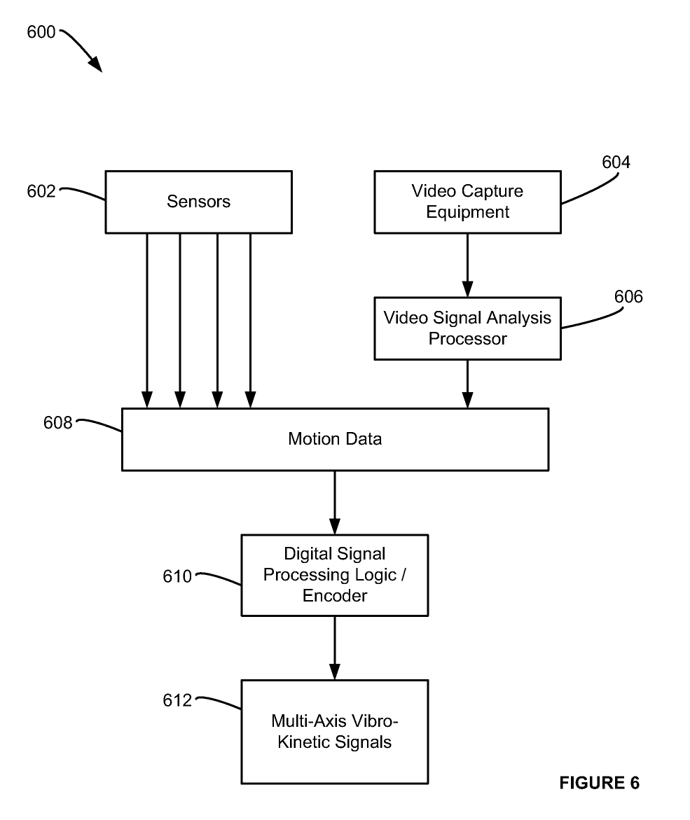

Now referring to FIG. 6, there is shown a block diagram of a system 600 for producing multi-axis vibro-kinetic signals used in controlling the movements of a motion platform (not shown). As discussed earlier, the source for the motion data 608 can be from motion sensors 602 or from audio/video capture equipment 604. In the case where audio/video capture equipment 604 is used, an audio/video signal analysis processor 606 receives audio/video signals from the audio/video capture equipment 604 and performs an analysis thereof to obtain motion data 608. The motion data 608, from any combination of sensors and audio/video signal analysis, is then forwarded to digital signal processing logic in an encoder 610 to generate multi-axis vibro-kinetic signals 612. The signal processing logic may include signal altering, delaying, or filtering,

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for rendering, to a user, a live event on a playback system, the live event, in which a subject participates, taking place at a first location and from which at least one of audio and video are captured, the playback system comprising a motion platform, and at least one of an audio playback system and a video playback system at a second location remote from the first location, the at least one of an audio playback system and a video playback system respectively for reproducing the captured at least one of audio and video, the method comprising:
capturing motion data representative of movements of the subject;
transmitting the motion data to a motion encoder;
the motion encoder generating motion signals for inducing motion to the motion platform, the motion corresponding to the motion data representative of movements of the subject; and
sending the motion signals to the motion platform to induce the motion to the motion platform synchronously with the at least one of audio, produced by the audio playback system, and video, produced by the video playback system, representative respectively of at least one of the audio and the video environment of the subject thereby synchronously rendering the motion, and at least one of the audio and the video to the user.

2. The method of claim 1, wherein the capturing motion data comprises reading data from one or more motion sensors installed on the subject:

3. The method of claim 1, wherein the capturing motion data comprises processing images of a live video stream of the subject to obtain the motion data representative of movements of the subject.

4. The method of claim 1, wherein the capturing motion data comprises capturing motion data representative of movements of a plurality of subjects and wherein the captured at least one of audio and video is representative of an environment of the plurality of subjects.

5. The method of claim 4, further comprising upon receipt of a user selection of one subject from the plurality of subjects, transmitting motion data representative of movements of the selected subject to thereby generate motion signals corresponding to movements of the selected subject.

6. The method of claim 5, further comprising at the motion platform, switching between different subjects to thereby render the live event specific to the selected subject.

7. The method of claim 4, further comprising, at the motion platform:
generating motion signals for a plurality of subjects; and
upon receipt of a user selection of switching between different subjects to thereby render the live event specific to the selected subject.

8. The method of claim 1, wherein the transmitting comprises transmitting the motion data along with at least one of a signal representative of audio, a signal representative of video, and a representative time reference over a communications network.

9. The method of claim 1, wherein the sending comprises sending the motion signals along with at least one of a signal representative of audio, a signal representative of video, and a representative time reference over a communications network.

10. The method of claim 1, wherein the capturing motion data comprises capturing motion data representative of movements of the subject in a range of frequencies between about 0 Hz and 600 Hz.

11. The method of claim 10, wherein the capturing motion data comprises capturing motion data representative of movements of the subject in a range of frequencies between about 0 Hz and 100 Hz.

12. A system for rendering to a user a live event on a playback system, the live event, in which a subject participates, taking place at a first location and from which at least one of audio and video are captured, the system comprising, at the first location:
a motion capture system for capturing motion data representative of movements of the subject; and
a transmitter for transmitting the motion data to a second location where the live event will be rendered on the playback system by synchronously producing a motion representative of the captured motion, with the captured at least one of audio and video to the user.

13. The system of claim 12, wherein the motion capture system comprises one or more motion sensors installed on the subject.

14. The system of claim 13, wherein the one or more motion sensors comprise one or more of at least one of accelerometers, gyrometers, magnetometers, inclinometers, and rotational or translational encoders.

15. The system of claim 12, wherein the motion capture system comprises a camera for capturing images representative of movement of the subject and determining motion data from the captured images.

16. The system of claim 15, wherein the determining further comprises graphically processing the captured images in real-time to determine the motion data.

17. The system of claim 12, further comprising the playback system which comprises:
a motion encoder, a motion platform, and at least one of an audio playback system and a video playback system;
the audio playback system for producing the audio and the video playback system for producing the video representative respectively of the audio and the video environment of the subject; and
the motion encoder for generating motion signals for sending to the motion platform to induce the motion to the motion platform synchronously with the at least one of the audio and the video.

18. The system of claim 17, wherein the motion platform comprises a motion-enabled chair.

19. A system for controlling the movements of a motion platform in real-time based on the movements of a remote subject, the system comprising:
a motion capture system for monitoring the movements of the remote subject;
a central encoder for producing motion signals which cause the motion platform to produce movements corresponding to the movements of the remote subject; and
a first communication link for sending the motion signals from the central encoder to the motion platform in real-time.

20. A method for controlling movements of a motion platform in real-time based on the movements of a remote subject, the method comprising:
monitoring the movements of the remote subject in real-time;
generating motion signals which cause the motion platform to produce movements corresponding to the movements of the remote subject;
sending the motion signals to the motion platform in real-time.
